(19) United States
(12) Patent Application Publication
(10) Pub. No.: US 2021/0125133 A1
(43) Pub. Date: Apr. 29, 2021

(54) DISPATCH SYSTEM FOR SCHEDULING WORKERS

(71) Applicant: Vacasa LLC, Portland, OR (US)

(72) Inventors: Subechya PERSON, Portland, OR (US); Chris BRANTLEY, Portland, OR (US); Hiranmayi DUVVURI, Portland, OR (US); Travis GREEN, Portland, OR (US); Brian KIMMIG, Portland, OR (US)

(21) Appl. No.: 17/083,067

(22) Filed: Oct. 28, 2020

Related U.S. Application Data
(60) Provisional application No. 62/927,608, filed on Oct. 29, 2019.

(51) Int. Cl. G06Q 10/06

(52) U.S. Cl. CPC G06Q 10/063112; G06Q 50/10; G06Q 10/063116

(57) ABSTRACT

A dispatch system and associated method for scheduling workers may include scheduling workers to provide a service to one or more units in a spatial region. The system includes a Zone Module for partitioning the region into one or more unique zones, a Tier Module for classifying the workers based on performance, and a Time Estimation Module for estimating the time a worker may spend at a single unit. An embodiment of the dispatch system includes utilizing the system in a method for scheduling housekeepers to be dispatched to provide cleaning services to one or more units.

### CROSS-REFERENCES

The following applications and materials are incorporated herein, in their entireties, for all purposes: U.S. Provisional Patent Application Ser. No. 62/927,608, filed Oct. 29, 2019.

### FIELD

This disclosure relates to dispatch systems. More specifically, the disclosed embodiments relate to dispatching workers to units in a time-varying system.

### INTRODUCTION

Dispatch systems are often modeled after the traveling salesman problem (TSP), a well-known problem in optimization and computational complexity that poses the question: “for a finite number of points whose pairwise distances are known, what is the shortest route connecting all of the points?” As an NP-hard problem, exact solutions to the TSP for large systems require a very large amount of computation, with common solutions including heavy use of heuristics, approximations, and metaheuristics.

### SUMMARY

The present disclosure provides systems, apparatuses, and methods relating to dispatch systems.

A method, implemented in a data processing system, the method comprising:

utilizing one or more processors of a data processing system, automatically categorizing a plurality of workers of a selected geographical zone into tiers comprising at least a first tier and a second tier, wherein the geographical zone is selected from a plurality of geographical zones, and each of the geographical zones includes a plurality of workers configured to provide services to a plurality of nodes disposed within the zone, and wherein a corresponding expected duration of service is associated with each of the nodes; and

utilizing the one or more processors, sequentially selecting individual workers of the selected one of the zones, based on the tiers, and for each of the individual workers generating a schedule, wherein generating the schedule includes assigning a series of the nodes in the selected geographical zone to fill an available span of time associated with the worker, based on the expected durations of service for the series of nodes and travel times between each of the nodes.

In some embodiments, a data processing system for scheduling workers with respect to a number of nodes includes: a memory; one or more processors; a plurality of instructions stored in the memory and executable by the one or more processors to: automatically categorize a plurality of workers of a selected geographical zone into tiers comprising at least a first tier and a second tier, wherein the geographical zone is selected from a plurality of geographical zones, and each of the geographical zones includes a plurality of workers configured to provide services to a plurality of nodes disposed within the zone, and wherein a corresponding expected duration of service is associated with each of the nodes; sequentially select individual workers of the selected one of the zones, based on the tiers; and for each of the individual workers, generate a schedule, wherein generating the schedule includes assigning a series of the nodes in the selected geographical zone to fill an available span of time associated with the worker, based on the expected durations of service for the series of nodes and travel times between each of the nodes.

In some examples, a system for scheduling a plurality of workers with respect to a plurality of locations, includes processing logic configured to: automatically categorize a plurality of workers of a selected geographical zone into tiers comprising at least a first tier and a second tier, wherein the geographical zone is selected from a plurality of geographical zones, and each of the geographical zones includes a plurality of workers configured to provide services to a plurality of nodes disposed within the zone, and wherein a corresponding expected duration of service is associated with each of the nodes; and sequentially select individual workers of the selected one of the zones, based on the tiers; and for each of the individual workers, generate a schedule, wherein generating the schedule includes assigning a series of the nodes in the selected geographical zone to fill an available span of time associated with the worker, based on the expected durations of service for the series of nodes and travel times between each of the nodes.

Features, functions, and advantages may be achieved independently in various embodiments of the present disclosure, or may be combined in yet other embodiments, further details of which can be seen with reference to the following description and drawings.

### BRIEF DESCRIPTION OF THE DRAWINGS

FIG. 1 is a schematic overview of an illustrative dispatch system in accordance with aspects of the present disclosure.

FIG. 2 is a schematic diagram depicting an example of a single graph partitioning into two subgraphs.

FIG. 3 is a flowchart depicting steps of an illustrative method for partitioning a spatial region by a specified characteristic.

FIG. 4 is a flowchart depicting steps of an illustrative method for scheduling housekeepers.

FIG. 5 is a flowchart depicting steps of an illustrative method for creating a time estimation model.

FIG. 6 is a flowchart depicting steps of an illustrative method for classifying housekeepers by tier.

FIG. 7 is a flowchart depicting steps of an illustrative method for scheduling housekeepers by tier.

FIG. 8 is a schematic diagram of an illustrative data processing system suitable for use as or with aspects of the present disclosure.

FIG. 9 is a schematic diagram of an illustrative distributed data processing system suitable for use as or with aspects of the present disclosure.

### DETAILED DESCRIPTION

Various aspects and examples of a dispatch and scheduling system are described below and illustrated in the associated drawings. Unless otherwise specified, a system in accordance with the present teachings, and/or its various components, may contain at least one of the structures, components, functionalities, and/or variations described, illustrated, and/or incorporated herein. Furthermore, unless specifically excluded, the process steps, structures, components, functionalities, and/or variations described, illustrated, and/or incorporated herein in connection with the present teachings may be included in other similar devices and methods, including being interchangeable between disclosed embodiments. The following description of various examples is merely illustrative in nature and is in no way intended to limit the disclosure, its application, or uses. Additionally, the advantages provided by the examples and embodiments described below are illustrative in nature and not all examples and embodiments provide the same advantages or the same degree of advantages.

This Detailed Description includes the following sections, which follow immediately below: (1) Definitions; (2) Overview; (3) Examples, Components, and Alternatives; (4) Advantages, Features, and Benefits; and (5) Conclusion. The Examples, Components, and Alternatives section is further divided into subsections A through E, each of which is labeled accordingly.

### Definitions

The following definitions apply herein, unless otherwise indicated.

“Comprising,” “including,” and “having” (and conjugations thereof) are used interchangeably to mean including but not necessarily limited to, and are open-ended terms not intended to exclude additional, unrecited elements or method steps.

Terms such as “first”, “second”, and “third” are used to distinguish or identify various members of a group, or the like, and are not intended to show serial or numerical limitation.

“AKA” means “also known as,” and may be used to indicate an alternative or corresponding term for a given element or elements.

“Processing logic” means any suitable device(s) or hardware configured to process data by performing one or more logical and/or arithmetic operations (e.g., executing coded instructions). For example, processing logic may include one or more processors (e.g., central processing units (CPUs) and/or graphics processing units (GPUs)), microprocessors, clusters of processing cores, FPGAs (field-programmable gate arrays), artificial intelligence (AI) accelerators, digital signal processors (DSPs), and/or any other suitable combination of logic hardware.

In this disclosure, one or more publications, patents, and/or patent applications may be incorporated by reference. However, such material is only incorporated to the extent that no conflict exists between the incorporated material and the statements and drawings set forth herein. In the event of any such conflict, including any conflict in terminology, the present disclosure is controlling.

### Overview

In general, a dispatch system for scheduling workers defines a spatial or geographic region (such as a city, state, etc.) having units or nodes, each unit having one or more known characteristics, such as size, location, resource allocation, etc. The units may be houses, apartments, businesses, and/or the like. The units can be at any location in the spatial region, and are each connected by at least one path to another unit in the region. One or more workers may travel between the units, e.g., to provide the resource allocated for each unit. In some examples, there may be different worker types (e.g., employees, contractors, etc.).

In general, the system is configured to provide each worker with a schedule comprising an ordered or unordered list of units to be visited. The dispatch system of the present disclosure constructs an optimal schedule for each worker to ensure that every unit in the spatial region receives its resource allocation. The dispatch system may consider the availability of each worker (e.g., whether or not each worker is scheduled for the day, is already working on a unit, has called in sick, etc.) to determine the scheduling order. Additionally, or alternatively, the dispatch system may consider the capacity of a unit when determining the number of workers to schedule for the unit. In some examples, the workers may be housekeepers dispatched to provide a resource (e.g., cleaning services) to nodes or units (e.g., rental properties).

The dispatch system includes several modules configured to carry out particular tasks or execute selected algorithms (e.g., asynchronously with respect to each other) to achieve the overall objective. For example, the dispatch system may include a Zone Module configured to partition the spatial region into a plurality of zones. Each zone may have a unique scheduling algorithm optimized for the specific zone. This partitioning may be dependent on the one or more characteristics of the units. For example, the spatial region may be partitioned according to location, such that each unit located within a specific boundary is placed in the same zone (e.g., the partitioning may be done by county within a particular U.S. state). In some examples, the workers are assigned and restricted to a single zone. This ensures a worker cannot be automatically scheduled to visit a unit outside of the partitioned boundary of his or her zone. In some example, workers may be assigned to one or more zones. Additionally, or alternatively, if a first zone has an insufficient number of workers to visit all the requisite units, the zone may adaptively pull workers from a second zone.

In some examples, the dispatch system includes a Tier Module configured to classify the workers within a stratified tier system. The tier system has a plurality of tiers, each defined by relevant (e.g., desired) worker characteristics. For example, the tiers may classify the workers based on performance, reliability, predictability, etc. The tier of a given worker influences the order in which that worker is scheduled to be dispatched. For example, a first worker qualifying for a better (e.g., higher) tier than a second worker may be scheduled before the second worker. This introduces systemic biasing to ensure the highest performing workers are dispatched reliably and predictably. This may increase the retention of higher-tier (presumably higher-performing) workers. The Tier module may additionally be configured to create a plurality of tiers based on worker type. For example, the workers of one type (e.g., employees) may have a unique tier system as compared with workers of another type (e.g., contractors).

In some examples, the dispatch system includes a Time Estimation Module. The Time Estimation Module is configured to estimate the time a worker is expected to spend at a unit to ensure the unit receives the allocated resource(s) for that unit. The time estimation model may depend on one or more characteristics of the unit (e.g., size, location, etc.) and/or one or more characteristics of the worker (e.g., tier, historical data, etc.). The Time Estimation Module may utilize a trained machine learning model and/or other statistical model.

In general, the dispatch system of the present disclosure includes monitoring availability of the workers and adaptively changing the scheduling order based on that availability. Additionally, or alternatively, the dispatch system may include forecasting the availability of the workers and adaptively changing the scheduling order based on the forecasted availability of the workers.

Technical solutions are disclosed herein for the scheduling of a dispatch system for workers traveling between nodes in defined regions. Specifically, the disclosed system and method address a technical problem tied to computing an optimal scheduling order for a worker dispatch system. The system and method disclosed herein provide an improved solution to this technical problem by utilizing a novel scheduling method and one or more machine learning techniques. Technical solutions described herein include advantageously computing aspects of the dispatch system in parallel, providing a speedup in computation time and an increase in the scalability of the dispatch system.

Aspects of the dispatch system may be embodied as a computer method, computer system, or computer program product. Accordingly, aspects of the dispatch system may take the form of an entirely hardware embodiment, an entirely software embodiment (including firmware, resident software, micro-code, and the like), or an embodiment combining software and hardware aspects, all of which may generally be referred to herein as a “circuit,” “module,” or “system.” Furthermore, aspects of the dispatch system may take the form of a computer program product embodied in a computer-readable medium (or media) having computer-readable program code/instructions embodied thereon.

Any combination of computer-readable media may be utilized. Computer-readable media can be a computer-readable signal medium and/or a computer-readable storage medium. A computer-readable storage medium may include an electronic, magnetic, optical, electromagnetic, infrared, and/or semiconductor system, apparatus, or device, or any suitable combination of these. More specific examples of a computer-readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, and/or any suitable combination of these and/or the like. In the context of this disclosure, a computer-readable storage medium may include any suitable non-transitory, tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, and/or any suitable combination thereof. A computer-readable signal medium may include any computer-readable medium that is not a computer-readable storage medium and that is capable of communicating, propagating, or transporting a program for use by or in connection with an instruction execution system, apparatus, or device.

Program code embodied on a computer-readable medium may be transmitted using any appropriate medium, including but not limited to wireless, wireline, optical fiber cable, RF, and/or the like, and/or any suitable combination of these.

Computer program code for carrying out operations for aspects of the dispatch system may be written in one or any combination of programming languages, including an object-oriented programming language (such as Java, C++), conventional procedural programming languages (such as C), and functional programming languages (such as Haskell). Mobile apps may be developed using any suitable language, including those previously mentioned, as well as Objective-C, Swift, C#, HTML5, and the like. The program code may execute entirely on a user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), and/or the connection may be made to an external computer (for example, through the Internet using an Internet Service Provider).

Aspects of the dispatch system may be described below with reference to flowchart illustrations and/or block diagrams of methods, apparatuses, systems, and/or computer program products. Each block and/or combination of blocks in a flowchart and/or block diagram may be implemented by computer program instructions. The computer program instructions may be programmed into or otherwise provided to processing logic (e.g., a processor of a general purpose computer, special purpose computer, field programmable gate array (FPGA), or other programmable data processing apparatus) to produce a machine, such that the (e.g., machine-readable) instructions, which execute via the processing logic, create means for implementing the functions/acts specified in the flowchart and/or block diagram block(s).

Additionally or alternatively, these computer program instructions may be stored in a computer-readable medium that can direct processing logic and/or any other suitable device to function in a particular manner, such that the instructions stored in the computer-readable medium produce an article of manufacture including instructions which implement the function/act specified in the flowchart and/or block diagram block(s).

The computer program instructions can also be loaded onto processing logic and/or any other suitable device to cause a series of operational steps to be performed on the device to produce a computer-implemented process such that the executed instructions provide processes for implementing the functions/acts specified in the flowchart and/or block diagram block(s).

Any flowchart and/or block diagram in the drawings is intended to illustrate the architecture, functionality, and/or operation of possible implementations of systems, methods, and computer program products according to aspects of the dispatch system. In this regard, each block may represent a module, segment, or portion of code, which comprises one or more executable instructions for implementing the specified logical function(s). In some implementations, the functions noted in the block may occur out of the order noted in the drawings. For example, two blocks shown in succession may, in fact, be executed substantially concurrently, or the blocks may sometimes be executed in the reverse order, depending upon the functionality involved. Each block and/or combination of blocks may be implemented by special purpose hardware-based systems (or combinations of special purpose hardware and computer instructions) that perform the specified functions or acts.

### Examples, Components, and Alternatives

The following sections describe selected aspects of exemplary dispatch systems as well as related systems and/or methods. The examples in these sections are intended for illustration and should not be interpreted as limiting the scope of the present disclosure. Each section may include one or more distinct embodiments or examples, and/or contextual or related information, function, and/or structure.

### A. Illustrative Dispatch System

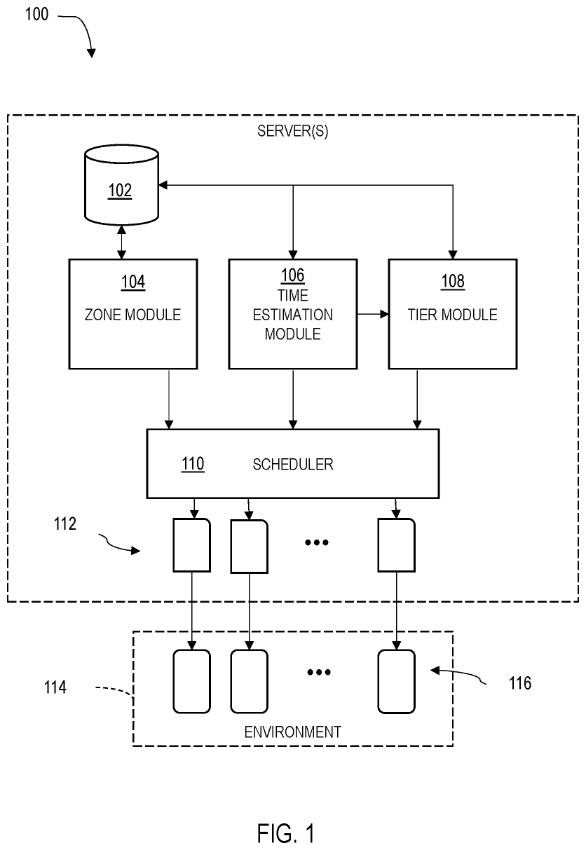

This section describes a dispatch system 100 for scheduling and assigning workers to a plurality of nodes or units (e.g., houses, locations, businesses, etc.) in a spatial region; see FIG. 1. Aspects of the dispatch system described above may be utilized in the system described below. Where appropriate, reference may be made to components and systems that may be used in carrying out each step. These references are for illustration, and are not intended to limit the possible ways of carrying out any particular step of the method.

Dispatch system 100 includes a data store 102 that contains data regarding a plurality of workers (e.g., location, time spent at units, classifying characteristics, etc.) and a plurality of units (e.g., location, size of unit, classifying characteristics, etc.). Data store 102 is in operable communication with a Zone Module 104, a Time Estimation Module 106, and a Tier Module 108. Each of these three modules is configured to provide information to a Scheduler 110.

Scheduler 110 utilizes one or more of the three modules to generate one or more schedules 112. Data store 102, Zone Module 104, Time Estimation Module 106, Tier Module 108, Scheduler 110, and schedules 112 are hosted on one or more servers, e.g., in network communication with each other. Schedules 112 are output such that they are available in an external environment 114, e.g., to be received by the workers as individual instructions 116. Instructions 116 may be provided to a worker's personal electronic device (AKA mobile digital device or MDD) in any human-readable manner, e.g., as text, audio, points on a map, and/or the like, and/or may be printed onto paper, translated, or otherwise altered.

The workers are capable of traveling throughout the spatial region and capable of providing a resource to one or more of the units. For example, the resource may include an action (e.g., cleaning), item delivery (e.g., mail), and/or other resource(s). The number of workers may be less than, equal to, or greater than the number of units. Dispatch system 100 is configured to assign one or more workers to one or more units, such that each unit is visited within a predetermined time frame. Dispatch system 100 may also be configured to identify units and/or zones with an insufficient number of workers. In this example, dispatch system 100 may output a notification identifying the insufficiency. Dispatch system 100 may additionally consider the capacity of one or more units when determining the number of workers to schedule. For example, a high capacity unit may have more workers scheduled to it than another unit having a lower capacity,

The spatial region can be represented as an undirected weighted graph having nodes and edges. The nodes represent units having associated characteristics such as size, location, required resource allocation, or any other measurable and/or calculable characteristics. The edge weights represent a cost of travel between units. The cost of travel can represent physical values such as distance and/or time, or abstract values such as price and/or difficulty. For example, if two nodes represent houses, the edge weight between the two nodes may represent a driving distance between the two houses. In some examples, the nodes represent apartments (or the like), and edge weights represent elevator (or stairway) travel time in a multistoried building.

Dispatch system 100 generates schedule 112 for each worker by considering every possible (or feasible) combination of worker, units, and paths. Full and partial graph traversals by each worker may be considered. Dispatch system 100 identifies the collection of routes that best meets a selected criterion or set of criteria (e.g., lowest travel distances, lowest travel times, least expensive, etc.) while also guaranteeing each unit is visited. Depending on the selected schedule(s) 112, some workers may not be assigned instructions 116. The set of modules (Zone Module 104, Time Estimation Module 106, and Tier Module 108) are employed by dispatch system 100 to limit the number of workers and units considered when generating schedules 112. Limiting the workers and units in this manner decreases the complexity and computation time needed for generating schedules 112.

Zone Module 104 is configured to partition the spatial region into two or more zones, based on selected characteristic(s) of the units and/or the spatial region. The selected characteristic(s) may include physical location of the units, number of units, cost to travel between units, and/or the like. In some examples, the zones are partitioned based on distance and proximity between units (e.g., all the units within a spatial boundary are grouped together in a zone). In some examples, the zones are partitioned based on a characteristic resource associated with each unit (e.g., all units within a boundary with onsite laundry service may be partitioned together into a single zone).

Each zone may be represented as a unique induced subgraph of the original weighted-graph representation of the spatial region, having fewer nodes and edges than the original graph. In this manner, each zone functions as a closed system having a unique set of units that differ from the units of any other zone. The partitioning of the spatial region into zones may be dynamic and/or adaptive to changes (e.g., in the units and/or workers). For example, more units may be added to the dispatch system 100 in a specific region. In response, a new partition may be applied, such that a selected zone is split to two new zones. Furthermore, a unit may be added to a zone, removed from a zone, and/or multiple zones may be combined into a single zone (e.g. if some units in a zone no longer need scheduling, the remaining units in the zone may be combined with a nearby zone).

Each worker may be individually assigned to a specific zone or may be assigned to multiple zones. For example, workers that reside in a specific region (e.g., a specific city) may be preferentially assigned to a zone corresponding to that region. This reduces computation time by limiting the number of units considered for a given worker, and reduces travel time for the workers by ensuring that no worker is dispatched to a unit outside a reasonable travel distance. In this manner, the assignment of workers to zones enables more relevancy between a worker and the units in the assigned zone. Additionally, or alternatively, specific workers may be restricted from a certain unit and/or preferentially assigned to a certain unit. For example, this may be determined by a zone manager. The preferential assignment of a worker to a unit may give systemic bias to schedule the worker to the unit, but does not guarantee the worker will be assigned to the unit (i.e., the worker may have a higher chance of being assigned to the unit).

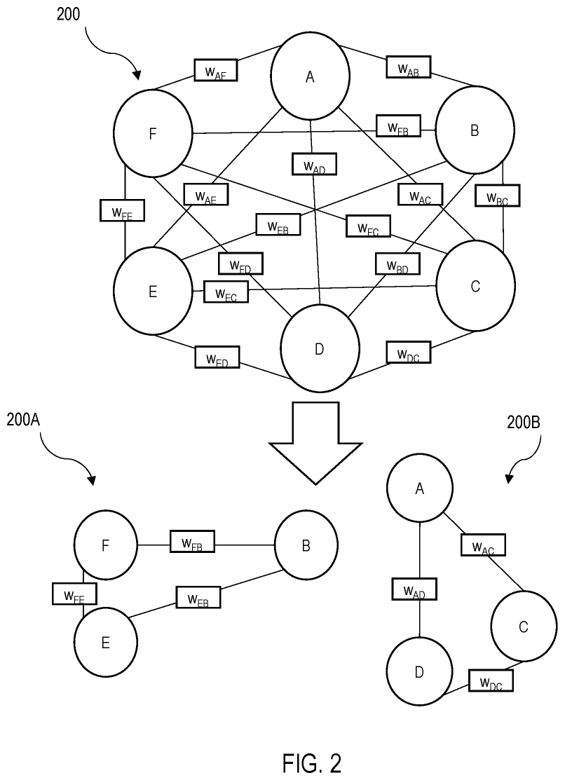

An example of subgraphs created by the partitioning process of Zone Module 104 is depicted in FIG. 2, where a graph 200 represents an illustrative spatial region. Graph 200 is a weighted graph having nodes (labeled A-F) and edges (labeled w_{xy}, where x and y represent the two nodes that the edge connects). In this example, the nodes are uniquely labeled, to enable identification of each node before and after the partitioning process. In this example, Zone Module 104 partitions the spatial region into two unique zones 200A and 200B. The partitioning process may generally be accomplished by first determining the characteristic of the units on which the partitioning depends (e.g., location, size, etc.). Zone Module 104 then determines which units are categorized together, based on the chosen characteristic. For example, if the characteristic for partitioning is traveling (e.g., driving) distance, Zone Module 104 may identify and group units within a selected traveling distance of each other (e.g., 10 miles).

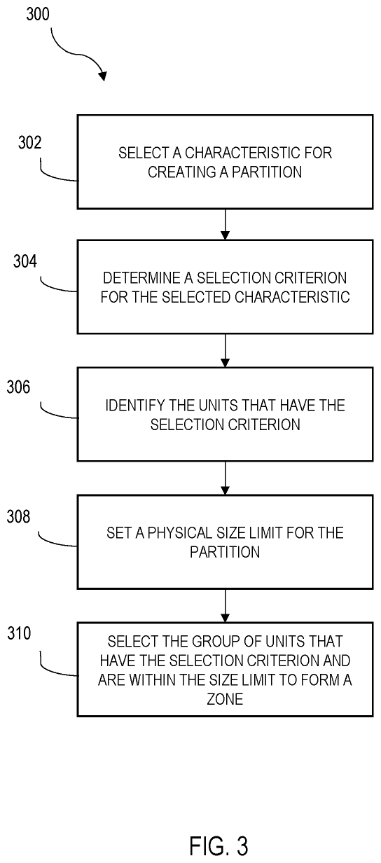

FIG. 3 is a flowchart illustrating steps in a partitioning method 300 for creating a partition in the spatial region to group units together into a zone. Method 300 may be suitable for use in Zone Module 104, as described herein. Although various steps of method 300 are described below and depicted in FIG. 3, the steps need not necessarily all be performed, and in some cases may be performed simultaneously or in a different order than the order shown.

At step 302, a characteristic is selected for partitioning the units. For example, the selected characteristic may be driving distance from a specified point.

At step 304, a corresponding selection threshold or criterion is determined. For example, if the selected characteristic is driving distance from a point, the selection criterion may be defined as a maximum driving distance (e.g., 5 miles) from the specified point.

At step 306, each unit meeting the selection criterion is identified in the spatial region. For example, respective driving distances from each unit to the specified point are measured and those units whose driving distance is less than 5 miles from the specified point are identified.

At step 308, a geographical or physical size limit for the partition is set. For example, the size might be set to a 10 square mile area centered around the specified point mentioned above, or a 12 mile by 11 mile rectangle, or any other suitable shape or size.

At step 310, the group of units that have been identified to meet the selection criterion for the characteristic and are also within the partition's physical size limit are selected to form a zone.

Dispatch system 100 further utilizes Time Estimation Module 106 configured to estimate the expected time spent at a unit. For example, in one embodiment, the workers are housekeepers dispatched to clean rental properties. In this example, Time Estimation Module 106 is configured to estimate the expected time to clean the property. Time Estimation Module 106 utilizes historical data regarding the time spent by previous workers at a specific unit (or type of unit) to generate an estimate for that unit.

In some examples, Time Estimation Module 106 utilizes a trained machine learning model or other numerical method to generate the time estimates. The specific method utilized by Time Estimation Module 106 may be dependent on a characteristic of the units (e.g., size). For example, in one embodiment, units that are below a certain size (e.g., 2000 sq. ft.) may use linear regression; while units that are larger may use gradient boosted trees. The machine learning model may be trained on historical data regarding the time spent at a given unit (e.g., the amount of time a housekeeper has historically spent cleaning a property). Time Estimation Module 106 may also train on data generated by simulations and/or other methods.

Dispatch system 100 further utilizes Tier Module 108, which is configured to classify the workers into a plurality of tiers. The tiers may be determined by a variety of worker characteristics. These worker characteristics may include performance-based characteristics (e.g., speed, quality, etc.), availability characteristics (reliability, predictability, etc.), and/or any other suitable characteristics associated with workers of the system in question. For example, a worker that has historically performed better (e.g., faster, more efficiently, more reliably, etc.) than another worker may be placed in a higher tier relative to that other worker. The respective tier of a worker may determine, in part, the scheduling order of the worker as determined by dispatch system 100. For example, a worker having a higher-tier classification may be preferentially scheduled over a lower-tier worker.

In some examples, there are three tiers: tier 1, tier 2, and tier 3. An example of scheduling workers by tier is as follows: workers in tier 1 are preferentially assigned work first, followed by workers from tier 2, with workers in tier 3 being reserved only for overflow work. More specific examples of tier scheduling are discussed further in the next section.

The stratification into tiers helps to ensure that workers having a history of good performance are more reliably assigned to units. This facilitates a higher retention rate of top-tier workers and establishes a systemic bias towards better performance, reliability, and/or predictability.

Dispatch system 100 incorporates active monitoring of a worker's proximity to a unit to adaptively change the scheduling. For example, an e-lock on a unit may transmit a signal to dispatch system 100 indicating a worker has finished their last scheduled unit and may have time to be adaptively scheduled to another unit. Dispatch system 100 may further utilize an e-lock to signal when a unit is empty. For example, if the unit is a short-term rental unit that needs cleaning by a housekeeper, the e-lock may signal when a customer checks out of the rental unit, thereby allowing the housekeeper to be adaptively scheduled to clean the unit.

Additionally, dispatch system 100 may dynamically schedule one or more workers to a last-minute unit addition (e.g., a unit that was not considered during scheduling, but requires an unexpected visit from a worker). In some examples, dispatch system 100 identifies a worker that has been assigned a proximate unit and/or a unit requiring a similar resource and schedule the worker to the last-minute unit addition. In another example, the worker is manually scheduled to the last-minute unit addition (e.g., by a zone manager).

Additionally, dispatch system 100 may consider the availability of one or more workers when determining whether or not to schedule them to a unit. For example, a worker that is not working on a certain day will not be automatically scheduled to a unit on that day.

### B. Illustrative Method for Scheduling Housekeepers

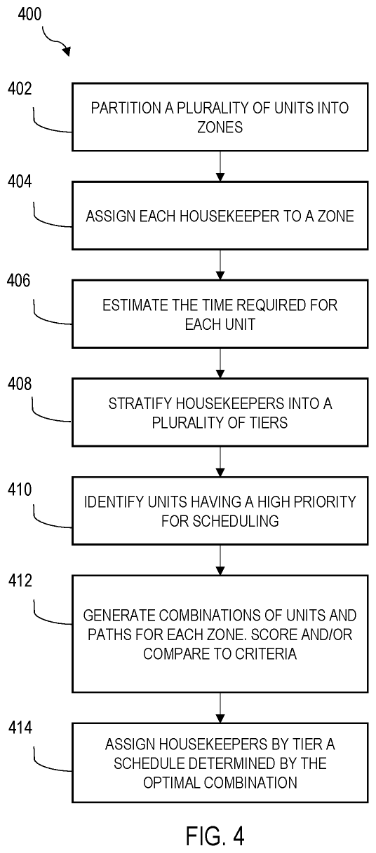

This section describes a method 400 for scheduling housekeepers to be dispatched to clean a plurality of units; see FIG. 4. Any aspect of dispatch system 100 described above may be utilized in the method steps described below. Where appropriate, reference may be made to components and systems that may be used in carrying out each step. These references are for illustration, and are not intended to limit the possible ways of carrying out any particular step of the method.

Method 400 assigns a plurality of housekeepers cleaning work for one or more units in a spatial region. Each housekeeper is supplied a schedule by the system, according to the steps described below. The schedule may be an ordered list (e.g., a list of units to visit and clean in a specified order) or an unordered list. In some examples, the schedule may be sent to a housekeeper's personal electronic device or MDD. The personal electronic device may be, for example, a smart phone, a personal computer, or any other data processing system as described below. The schedule may include any human-readable information, such as text instructions, audio, symbols, visualized locations on a map, etc. The schedule may be printed on paper, handwritten, translated into another language and/or otherwise altered from its original form. The housekeepers may then be dispatched to their respective assigned units according to the schedule, to ensure that each scheduled unit is cleaned or otherwise serviced.

In general, the spatial region of the present embodiment is substantially similar to the spatial region described above and may be partitioned into zones. Each zone may be represented as a subgraph which contains nodes representing only the units for the zone and edges representing the travel distance between units. Each housekeeper may be assigned to a zone. The units in this embodiment include any combination of houses, apartments, condos, businesses, and/or any other building that may utilize a centralized cleaning service. Method 400 may utilize a Zone Module, Time Estimation Module, and Tier Module in the housekeeper scheduling steps described below. These modules may be substantially similar to those described above.

For each housekeeper being scheduled, method 400 considers a number of feasible combinations of units and paths to find a combination of units and paths for each housekeeper that meets one or more criteria (e.g., minimum total travel time, priority of clean, etc.). This search is performed on the subgraph representing the zone being scheduled. For example, assuming a housekeeper is limited to 4 hours, combinations of units and paths in the housekeeper's zone are generated. In some examples, the combination with the least required travel time that visits the highest number of units in 4 hours is identified and assigned to the housekeeper. Through the utilization of the Zone Module, Time Estimation Module, and Tier Module, the searching space (and therefore the amount of computation required) is greatly diminished.

FIG. 4 is a flowchart illustrating steps of method 400 for scheduling housekeepers. Although various steps of method 400 are described below and depicted in FIG. 4, the steps need not necessarily all be performed, and in some cases may be performed simultaneously or in a different order than the order shown.

At step 402, the units in the spatial region are partitioned into zones by the Zone Module.

At step 404, each housekeeper is assigned to a zone. The specific zone assigned may depend on each housekeeper's location and proximity to a zone.

At step 406, the Time Estimation Module estimates the time to clean each unit. The Time Estimation Module of the present embodiment is described further below.

At step 408, the Tier Module stratifies the housekeepers into a plurality of tiers. The Tier Module of the present embodiment is described further below.

At step 410, for each zone: identify any units having a high priority for scheduling. For example, units requiring back-to-back cleaning are identified as high priority units.

At step 412, for each zone: combinations of units and paths are generated and combinations meeting selected criteria are identified. High priority units, as identified at step 410, are preferentially considered as combinations of units and paths are generated. If more than one combination meets the selected criteria, then further selection rules may be applied (e.g., a tie-breaking function). For example, if two combinations result in a total travel time below a given threshold, then one of the combinations may be selected based on the lower total distance traveled. The combinations of units and paths generated may be preferentially considered by type of clean. For example, the units requiring multiple housekeepers may be processed before units requiring a single housekeeper, etc.

At step 414, the housekeepers are assigned respective schedules corresponding to the combinations identified. The order of scheduling a housekeeper is dependent on the tier of the housekeeper and an example of ordering by tier is described further below.

The Zone Module of the present embodiment is configured to partition the spatial region into the zones according to location. Zones may be based on existing political boundaries, such as when the zones are representative of states, counties, cities, or neighborhoods. In some examples, zones may be determined through categorizing units by a traveling-distance limit or an as-the-crow-flies distance radius (e.g., all units within a 15-mile radius may be placed in the same zone). The size of the zones may adapt to the number of units in the region or to the number of housekeepers to be scheduled.

The Time Estimation Module of the present embodiment utilizes one of two predictive models, depending on a size classification for each unit. Specifically, the Time Estimation Module utilizes linear regression for small units and gradient boosted trees for large units. However, other suitable predictive models may be used, either additionally or alternatively. Small units and large units may be differentiated by a threshold size (e.g., 1500 sq. ft.) or may be differentiated by a categorization algorithm. In examples having a categorization algorithm, the Time Estimation Module utilizes unit characteristics such as size, room count, room types, etc., to differentiate between the two classes of units (i.e., small units and large units). The two classes of units may correspond directly to the square footage of the units or may correspond to another characteristic such as number of rooms to be cleaned. For each of the two classes of units, an associated dataset containing unit data (e.g., unit size, average time-to-clean, etc), namely a large-unit dataset and a small-unit dataset. Each of these two datasets may be stored in the data store described above.

With respect to small units, the Time Estimation Module utilizes linear regression to determine a relationship between the size of the unit and the estimated time to clean the unit. Historical data indicating the time spent cleaning each unit (e.g., measured in minutes) may be averaged by unit, mapped as a function of unit size (e.g., measured in square feet), and stored in the small-unit dataset. Linear regression is then applied to the small-unit data set to determine an estimated linear relationship between unit size and average time spent cleaning. Therefore, given (as input) the size of any unit in the “small unit” classification, the time estimate module may supply a corresponding time estimate value.

With respect to large units, historical data indicating the time spent cleaning each unit may be averaged by unit, mapped as a function of unit size, and stored in the large-unit dataset. For the large unit class, it is expected that there may not be a linear relationship between unit size and average time-to-clean. Thus, linear regression may not sufficiently model the relationship to a high degree of accuracy. The Time Estimation Module may therefore utilize gradient boosted trees to form a predictive model for time estimation.

Gradient boosted trees utilize an ensemble of trees to create a model for characterization and prediction. The ensemble of trees may consist of shallow trees for a low learning rate or more complex trees for a higher learning rate. To begin training a gradient boosted tree model, a first tree is generated to attempt to determine predictive classifications in the data. In some examples, this seeding may be done randomly, or may utilize a stochastic method. Each successive tree is generated with a modified structure of the previous tree to attempt to better fit the data. The modified structure of each successive generation attempts to optimize a differentiable loss function. With a low loss value, the model will be trained to provide classification and prediction on the data. Specifically, the Time Estimation Module utilizes this training procedure on the large-unit dataset to generate a predictive model on estimated time-to-clean. Additionally, the Time Estimation Module may include identifying the time required for mandatory stops (e.g., laundry stops, supply stops, etc.) in the time estimation.

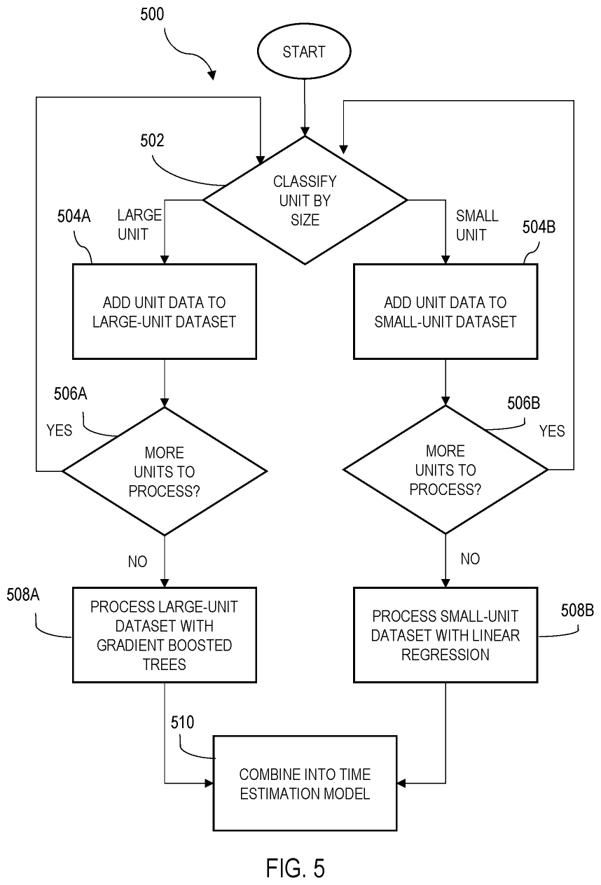

FIG. 5 is a flowchart illustrating steps of a time estimation method 500 utilized by the Time Estimation Module for estimating the expected time to clean a unit. Although various steps of method 500 are described below and depicted in FIG. 5, the steps need not necessarily all be performed, and in some cases may be performed simultaneously or in a different order than the order shown.

At step 502, the Time Estimation Module classifies a unit into either a large unit class or a small unit class. If classified as a large unit, the Time Estimation Module continues to step 504A. If classified as a small unit, the Time Estimation Module continues to step 504B.

At step 504A, the Time Estimation Module adds the unit data to the large-unit dataset. Then the Time Estimation Module continues to step 506A.

At step 504B, the Time Estimation Module adds the unit data to the small-unit dataset. Then the Time Estimation Module continues to step 506B.

At step 506A, the Time Estimation Module determines if there are more units to process; if so, the Time Estimation Module returns to step 502 to examine the next unit to be processed. Otherwise, the Time Estimation Module continues to step 508A.

At step 506B, the Time Estimation Module determines if there are more units to process; if so, the Time Estimation Module returns to step 502 to examine the next unit to be processed. Otherwise, the Time Estimation Module continues to step 508B.

At step 508A, the Time Estimation Module processes the large-unit data with gradient boosted trees to produce a first predictive, time-estimation model.

At step 508B, the Time Estimation Module processes the small-unit data with linear regression to produce a second predictive, time-estimation model.

At step 510, the Time Estimation Module combines the first and second predictive, time-estimation models to produce a final time-estimation model that estimates the time to clean a unit of any size.

The Tier Module of the present embodiment classifies housekeepers into one of three tiers. The three-tier classification is dependent on characteristics of the housekeepers including an aggregate difference D_{A} between their recorded time to clean a unit and the estimated time to clean the unit (as estimated by the final time-estimation model described previously) and a reported score S of the cleanliness of the unit after the cleaning is finished.

To determine aggregate difference D_{A} for a housekeeper's cleaning time, the estimated time for cleaning a unit can be subtracted from the recorded time to clean the unit to determine a single difference. Each of these single differences may then be averaged together for a final D_{A} value. A D_{A} value of ‘0’ indicates the housekeeper spent, on average, the same amount of time as estimated to clean their units, a positive D_{A} value indicates the housekeeper spent, on average, longer than estimated, and a negative D_{A} indicates the housekeeper was faster than estimated.

An aggregate difference threshold value, D_{T}, may be utilized to determine the lowest tier of housekeepers: tier 3 (i.e., the tier that is scheduled last and corresponds to a lower performance). For example, all housekeepers in which D_{A}>D_{T}, may be placed in tier 3. The housekeepers whose aggregate difference is X≤D_{A}<D_{T} may be placed in tier 2 (where X may represent any value from 0 to D_{T}). The housekeepers whose aggregate difference is less than X may be placed in either tier 1 or tier 2, depending on their reported score S. In this example, X may represent the mean value of a distribution and/or a tunable threshold value.

A housekeeper's reported score S is determined by averaging the individual scores for the cleanliness of each unit they have cleaned. This may include all the units the housekeeper has historically cleaned or only the most recent units. The individual scores for each unit may be given by a guest renting the unit, the owner of the unit, etc. An individual score may be a star rating (e.g., rated out of 5 stars), an integer value out of a range (e.g., a value out of 10), a percentage rating (e.g., a value out of 100%), or any other sufficient rating system.

A score threshold value S_{T} may be utilized to determine the highest tier of housekeepers: tier 1. For example, all housekeepers with a negative D_{A} value whose reported score S is greater than S_{T} may be placed in tier 1 and all housekeepers with a negative D_{A} value whose reported score S is less than S_{T} may be placed in tier 2.

All housekeepers who are new, and therefore have not cleaned a unit, are placed in tier 2 until sufficient D_{A} and S values have been created.

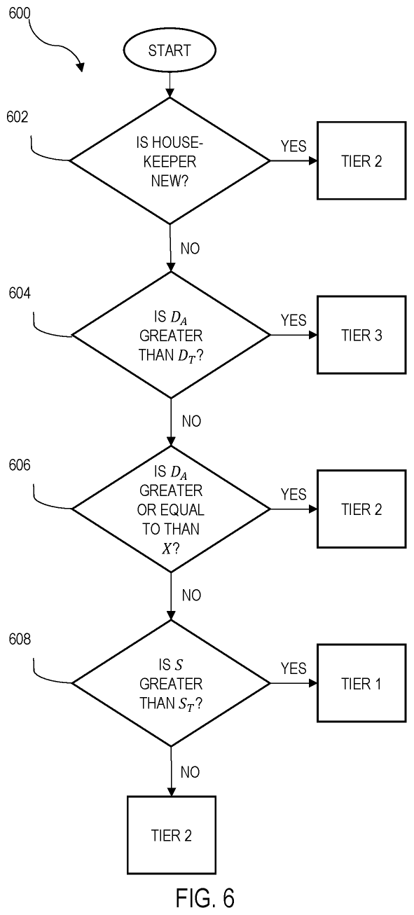

FIG. 6 is a flowchart illustrating steps of a decision-making method 600 for classifying housekeepers into one of three tiers. Although various steps of method 600 are described below and depicted in FIG. 6, the steps need not necessarily all be performed, and in some cases may be performed simultaneously or in a different order than the order shown.

At step 602, the Tier Module determines if a housekeeper is new (i.e., has not been assigned units in the past). If so, the housekeeper is placed in tier 2. If not, the Tier Module continues to step 604.

At step 604, the Tier Module determines if D_{A}>D_{T}. If so, the housekeeper is placed in tier 3. If not, the Tier Module continues to step 606.

At step 606, the Tier Module determines if D_{A}>X. If so, the housekeeper is placed in tier 2. If not, the Tier Module continues to step 608.

At step 608. the Tier Module determines if S>S_{T}. If so, the housekeeper is placed in tier 1. If not the housekeeper is placed in tier 2.

The tier of a housekeeper is utilized by the system for scheduling housekeepers to determine the order in which housekeepers are scheduled. In the present embodiment, for each zone that requires scheduling, the system may schedule one or more housekeepers from that zone to each unit that requires cleaning.

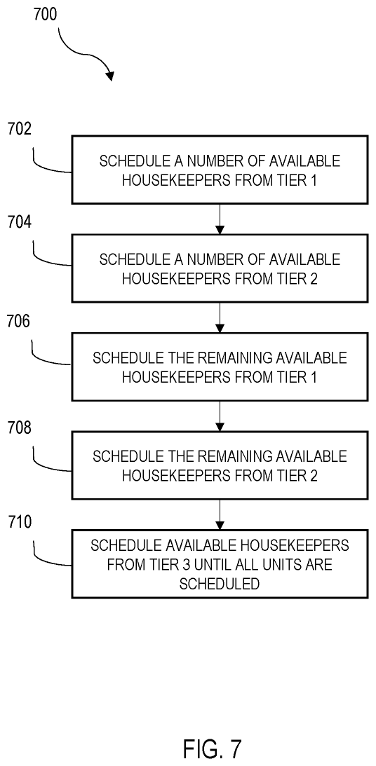

FIG. 7 is a flowchart depicting steps of a method 700 for choosing the tier-order to select housekeepers to be scheduled. Although various steps of method are described below and depicted in FIG. 7, the steps need not necessarily all be performed, and in some cases may be performed simultaneously or in a different order than the order shown.

At step 702, a number of available housekeepers from tier 1 are scheduled. The specific number of housekeepers from tier 1 may be dependent on the zone, the number of units to be cleaned, and the number of available housekeepers in tier 1.

At step 704, a number of available housekeepers from tier 2 are scheduled. The specific number of housekeepers from tier 2 may be dependent on the zone, the number of units to be cleaned, and the number of available housekeepers in tier 2.

At step 706, the remaining available housekeepers from tier 1 are scheduled until either each unit has a sufficient number of housekeepers assigned or there are no more available housekeepers in tier 1.

At step 708, the remaining available housekeepers from tier 2 are scheduled until either each unit has a sufficient number of housekeepers assigned or there are no more available housekeepers in tier 2.

At step 710, the available housekeepers from tier 3 are scheduled until either the remaining units have all been assigned a sufficient number of housekeepers or there are no more available housekeepers in tier 3. In the case that there are units remaining in the zone, but no more housekeepers available for scheduling, housekeepers from another zone may be reassigned to clean the excess units. This reassignment may be temporary or permanent. Additionally, or alternatively, in the case that there are units remaining in the zone and all the housekeepers have been scheduled, contract workers may be scheduled as a replacement. In general, the contract workers may be similarly tiered according to the steps described above.

### C. Illustrative Data Processing System

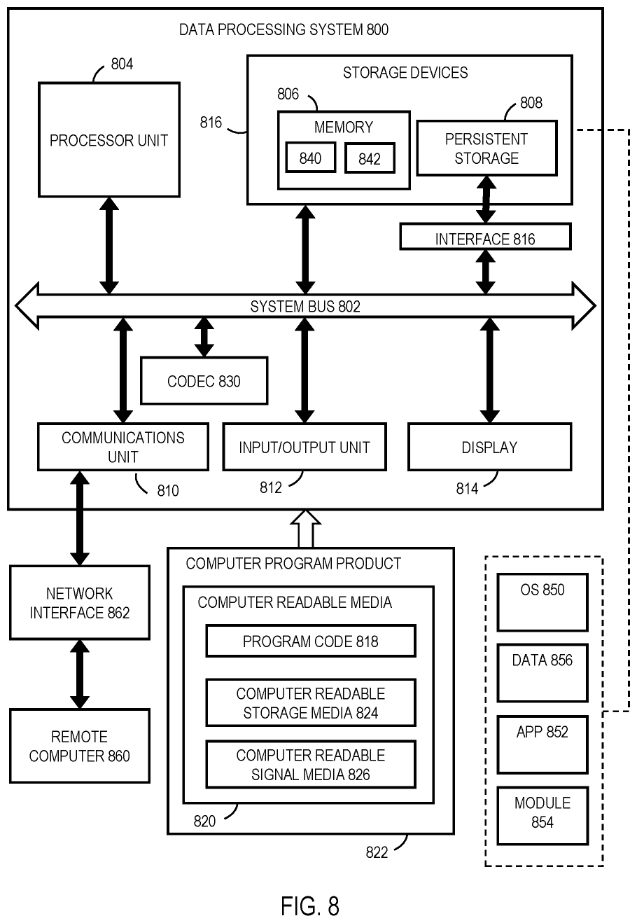

As shown in FIG. 8, this example describes a data processing system 800 (also referred to as a computer, computing system, and/or computer system) in accordance with aspects of the present disclosure. In this example, data processing system 800 is an illustrative data processing system suitable for implementing aspects of the dispatch system and/or the method for scheduling housekeepers. More specifically, in some examples, devices that are embodiments of data processing systems (e.g., smartphones, tablets, personal computers) may generate schedules for dispatching workers, may generate schedules for housekeeping services, may be configured to process steps of any of the described modules or methods described above, and may receive a schedule from the Scheduler (e.g., as a worker's MDD).

In this illustrative example, data processing system 800 includes a system bus 802 (also referred to as communications framework). System bus 802 may provide communications between a processor unit 804 (also referred to as a processor or processors), a memory 806, a persistent storage 808, a communications unit 810, an input/output (I/O) unit 812, a codec 830, and/or a display 814. Memory 806, persistent storage 808, communications unit 810, input/output (I/O) unit 812, display 814, and codec 830 are examples of resources that may be accessible by processor unit 804 via system bus 802.

Processor unit 804 serves to run instructions that may be loaded into memory 806. Processor unit 804 may comprise a number of processors, a multi-processor core, and/or a particular type of processor or processors (e.g., a central processing unit (CPU), graphics processing unit (GPU), etc.), depending on the particular implementation. Further, processor unit 804 may be implemented using a number of heterogeneous processor systems in which a main processor is present with secondary processors on a single chip. As another illustrative example, processor unit 804 may be a symmetric multi-processor system containing multiple processors of the same type.

Memory 806 and persistent storage 808 are examples of storage devices 816. A storage device may include any suitable hardware capable of storing information (e.g., digital information), such as data, program code in functional form, and/or other suitable information, either on a temporary basis or a permanent basis.

Storage devices 816 also may be referred to as computer-readable storage devices or computer-readable media. Memory 806 may include a volatile storage memory 840 and a non-volatile memory 842. In some examples, a basic input/output system (BIOS), containing the basic routines to transfer information between elements within the data processing system 800, such as during start-up, may be stored in non-volatile memory 842. Persistent storage 808 may take various forms, depending on the particular implementation.

Persistent storage 808 may contain one or more components or devices. For example, persistent storage 808 may include one or more devices such as a magnetic disk drive (also referred to as a hard disk drive or HDD), solid state disk (SSD), floppy disk drive, tape drive, Jaz drive, Zip drive, flash memory card, memory stick, and/or the like, or any combination of these. One or more of these devices may be removable and/or portable, e.g., a removable hard drive. Persistent storage 808 may include one or more storage media separately or in combination with other storage media, including an optical disk drive such as a compact disk ROM device (CD-ROM), CD recordable drive (CD-R Drive), CD rewritable drive (CD-RW Drive), and/or a digital versatile disk ROM drive (DVD-ROM). To facilitate connection of the persistent storage devices 808 to system bus 802, a removable or non-removable interface is typically used, such as interface 828.

Input/output (I/O) unit 812 allows for input and output of data with other devices that may be connected to data processing system 800 (i.e., input devices and output devices). For example, input device 832 may include one or more pointing and/or information-input devices such as a keyboard, a mouse, a trackball, stylus, touch pad or touch screen, microphone, joystick, game pad, satellite dish, scanner, TV tuner card, digital camera, digital video camera, web camera, and/or the like. These and other input devices may connect to processor unit 804 through system bus 802 via interface port(s) 836. Interface port(s) 836 may include, for example, a serial port, a parallel port, a game port, and/or a universal serial bus (USB).

Output devices 834 may use some of the same types of ports, and in some cases the same actual ports, as input device(s) 832. For example, a USB port may be used to provide input to data processing system 800 and to output information from data processing system 800 to an output device 834. Output adapter 838 is provided to illustrate that there are some output devices 834 (e.g., monitors, speakers, and printers, among others) which require special adapters. Output adapters 838 may include, e.g., video and sounds cards that provide a means of connection between the output device 834 and system bus 802. Other devices and/or systems of devices may provide both input and output capabilities, such as remote computer(s) 860. Display 814 may include any suitable human-machine interface or other mechanism configured to display information to a user, e.g., a CRT, LED, or LCD monitor or screen, etc.

Communications unit 810 refers to any suitable hardware and/or software employed to provide for communications with other data processing systems or devices. While communication unit 810 is shown inside data processing system 800, it may in some examples be at least partially external to data processing system 800. Communications unit 810 may include internal and external technologies, e.g., modems (including regular telephone grade modems, cable modems, and DSL modems), ISDN adapters, and/or wired and wireless Ethernet cards, hubs, routers, etc. Data processing system 800 may operate in a networked environment, using logical connections to one or more remote computers 860. A remote computer(s) 860 may include a personal computer (PC), a server, a router, a network PC, a workstation, a microprocessor-based appliance, a peer device, a smart phone, a tablet, another network note, and/or the like. Remote computer(s) 860 typically include many of the elements described relative to data processing system 800. Remote computer(s) 860 may be logically connected to data processing system 800 through a network interface 862 which is connected to data processing system 800 via communications unit 810. Network interface 862 encompasses wired and/or wireless communication networks, such as local-area networks (LAN), wide-area networks (WAN), and cellular networks. LAN technologies may include Fiber Distributed Data Interface (FDDI), Copper Distributed Data Interface (CDDI), Ethernet, Token Ring, and/or the like. WAN technologies include point-to-point links, circuit switching networks (e.g., Integrated Services Digital networks (ISDN) and variations thereon), packet switching networks, and Digital Subscriber Lines (DSL).

Codec 830 may include an encoder, a decoder, or both, comprising hardware, software, or a combination of hardware and software. Codec 830 may include any suitable device and/or software configured to encode, compress, and/or encrypt a data stream or signal for transmission and storage, and to decode the data stream or signal by decoding, decompressing, and/or decrypting the data stream or signal (e.g., for playback or editing of a video). Although codec 830 is depicted as a separate component, codec 830 may be contained or implemented in memory, e.g., non-volatile memory 842.

Non-volatile memory 842 may include read only memory (ROM), programmable ROM (PROM), electrically programmable ROM (EPROM), electrically erasable programmable ROM (EEPROM), flash memory, and/or the like, or any combination of these. Volatile memory 840 may include random access memory (RAM), which may act as external cache memory. RAM may comprise static RAM (SRAM), dynamic RAM (DRAM), synchronous DRAM (SDRAM), double data rate SDRAM (DDR SDRAM), enhanced SDRAM (ESDRAM), and/or the like, or any combination of these.

Instructions for the operating system, applications, and/or programs may be located in storage devices 816, which are in communication with processor unit 804 through system bus 802. In these illustrative examples, the instructions are in a functional form in persistent storage 808. These instructions may be loaded into memory 806 for execution by processor unit 804. Processes of one or more embodiments of the present disclosure may be performed by processor unit 804 using computer-implemented instructions, which may be located in a memory, such as memory 806.

These instructions are referred to as program instructions, program code, computer usable program code, or computer-readable program code executed by a processor in processor unit 804. The program code in the different embodiments may be embodied on different physical or computer-readable storage media, such as memory 806 or persistent storage 808. Program code 818 may be located in a functional form on computer-readable media 820 that is selectively removable and may be loaded onto or transferred to data processing system 800 for execution by processor unit 804. Program code 818 and computer-readable media 820 form computer program product 822 in these examples. In one example, computer-readable media 820 may comprise computer-readable storage media 824 or computer-readable signal media 826.

Computer-readable storage media 824 may include, for example, an optical or magnetic disk that is inserted or placed into a drive or other device that is part of persistent storage 808 for transfer onto a storage device, such as a hard drive, that is part of persistent storage 808. Computer-readable storage media 824 also may take the form of a persistent storage, such as a hard drive, a thumb drive, or a flash memory, that is connected to data processing system 800. In some instances, computer-readable storage media 824 may not be removable from data processing system 800.

In these examples, computer-readable storage media 824 is a non-transitory, physical or tangible storage device used to store program code 818 rather than a medium that propagates or transmits program code 818. Computer-readable storage media 824 is also referred to as a computer-readable tangible storage device or a computer-readable physical storage device. In other words, computer-readable storage media 824 is media that can be touched by a person.

Alternatively, program code 818 may be transferred to data processing system 800, e.g., remotely over a network, using computer-readable signal media 826. Computer-readable signal media 826 may be, for example, a propagated data signal containing program code 818. For example, computer-readable signal media 826 may be an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some illustrative embodiments, program code 818 may be downloaded over a network to persistent storage 808 from another device or data processing system through computer-readable signal media 826 for use within data processing system 800. For instance, program code stored in a computer-readable storage medium in a server data processing system may be downloaded over a network from the server to data processing system 800. The computer providing program code 818 may be a server computer, a client computer, or some other device capable of storing and transmitting program code 818.

In some examples, program code 818 may comprise an operating system (OS) 850. Operating system 850, which may be stored on persistent storage 808, controls and allocates resources of data processing system 800. One or more applications 852 take advantage of the operating system's management of resources via program modules 854, and program data 856 stored on storage devices 816. OS 850 may include any suitable software system configured to manage and expose hardware resources of computer 800 for sharing and use by applications 852. In some examples, OS 850 provides application programming interfaces (APIs) that facilitate connection of different type of hardware and/or provide applications 852 access to hardware and OS services. In some examples, certain applications 852 may provide further services for use by other applications 852, e.g., as is the case with so-called “middleware.” Aspects of present disclosure may be implemented with respect to various operating systems or combinations of operating systems.

The different components illustrated for data processing system 800 are not meant to provide architectural limitations to the manner in which different embodiments may be implemented. One or more embodiments of the present disclosure may be implemented in a data processing system that includes fewer components or includes components in addition to and/or in place of those illustrated for computer 800. Other components shown in FIG. 8 can be varied from the examples depicted. Different embodiments may be implemented using any hardware device or system capable of running program code. As one example, data processing system 800 may include organic components integrated with inorganic components and/or may be comprised entirely of organic components (excluding a human being). For example, a storage device may be comprised of an organic semiconductor.

In some examples, processor unit 804 may take the form of a hardware unit having hardware circuits that are specifically manufactured or configured for a particular use, or to produce a particular outcome or progress. This type of hardware may perform operations without needing program code 818 to be loaded into a memory from a storage device to be configured to perform the operations. For example, processor unit 804 may be a circuit system, an application specific integrated circuit (ASIC), a programmable logic device, or some other suitable type of hardware configured (e.g., preconfigured or reconfigured) to perform a number of operations. With a programmable logic device, for example, the device is configured to perform the number of operations and may be reconfigured at a later time. Examples of programmable logic devices include, a programmable logic array, a field programmable logic array, a field programmable gate array (FPGA), and other suitable hardware devices. With this type of implementation, executable instructions (e.g., program code 818) may be implemented as hardware, e.g., by specifying an FPGA configuration using a hardware description language (HDL) and then using a resulting binary file to (re)configure the FPGA.

In another example, data processing system 800 may be implemented as an FPGA-based (or in some cases ASIC-based), dedicated-purpose set of state machines (e.g., Finite State Machines (FSM)), which may allow critical tasks to be isolated and run on custom hardware. Whereas a processor such as a CPU can be described as a shared-use, general purpose state machine that executes instructions provided to it, FPGA-based state machine(s) are constructed for a special purpose, and may execute hardware-coded logic without sharing resources. Such systems are often utilized for safety-related and mission-critical tasks.

In another example, data processing system 800 may be implemented using a serverless architecture (also referred to as “function as a service” or FaaS), which is configured such that a task is isolated and run on an as-need basis on remote hardware. For example, the task instructions may be stored in one or more memory devices, and implemented by one or more processor units distributed in a computing cluster as determined by which processors are currently available. In this example, the task may be run on any of the available processors without explicitly sending the task to a certain processor.

In still another illustrative example, processor unit 804 may be implemented using a combination of processors found in computers and hardware units. Processor unit 804 may have a number of hardware units and a number of processors that are configured to run program code 818. With this depicted example, some of the processes may be implemented in the number of hardware units, while other processes may be implemented in the number of processors.

In another example, system bus 802 may comprise one or more buses, such as a system bus or an input/output bus. Of course, the bus system may be implemented using any suitable type of architecture that provides for a transfer of data between different components or devices attached to the bus system. System bus 802 may include several types of bus structure(s) including memory bus or memory controller, a peripheral bus or external bus, and/or a local bus using any variety of available bus architectures (e.g., Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI)).

Additionally, communications unit 810 may include a number of devices that transmit data, receive data, or both transmit and receive data. Communications unit 810 may be, for example, a modem or a network adapter, two network adapters, or some combination thereof. Further, a memory may be, for example, memory 806, or a cache, such as that found in an interface and memory controller hub that may be present in system bus 802.

### D. Illustrative Distributed Data Processing System

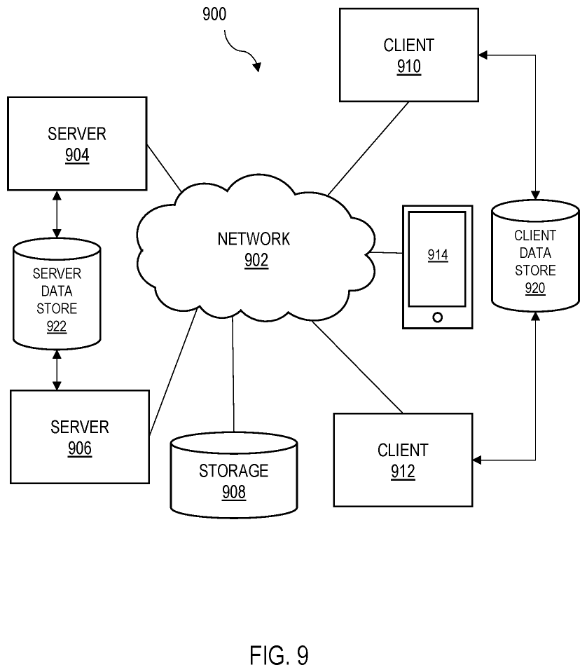

As shown in FIG. 9, this example describes a general network data processing system 900, interchangeably termed a computer network, a network system, a distributed data processing system, or a distributed networks, aspects of which may be included in one or more illustrative embodiments of the dispatch system and/or method for scheduling housekeepers. For example, aspects of the Tier Module, Zone Module, and/or Time Estimation Module may be in network communication with each other, the data store, and/or the Scheduler. The server(s) that are configured to process the steps of these modules, contain the data store, and utilize the processing logic configured to generate the schedules may be in network communication with the personal digital devices of the workers. If the dispatch system is hosted on more than one server, the servers may be in network communication with each other.

It should be appreciated that FIG. 9 is provided as an illustration of one implementation and is not intended to imply any limitation with regard to environments in which different embodiments may be implemented. Many modifications to the depicted environment may be made.

Network system 900 is a network of devices (e.g., computers), each of which may be an example of data processing system 800, and other components. Network data processing system 900 may include network 902, which is a medium configured to provide communications links between various devices and computers connected within network data processing system 900. Network 902 may include connections such as wired or wireless communication links, fiber optic cables, and/or any other suitable medium for transmitting and/or communicating data between network devices, or any combination thereof.

In the depicted example, a first network device 904 and a second network device 906 connect to network 902, as do one or more computer-readable memories or storage devices 908. Network devices 904 and 906 are each examples of data processing system 800, described above. In the depicted example, devices 904 and 906 are shown as server computers, which are in communication with one or more server data store(s) 922 that may be employed to store information local to server computers 904 and 906, among others. However, network devices may include, without limitation, one or more personal computers, mobile computing devices such as personal digital assistants (PDAs), tablets, and smartphones, handheld gaming devices, wearable devices, tablet computers, routers, switches, voice gates, servers, electronic storage devices, imaging devices, media players, and/or other networked-enabled tools that may perform a mechanical or other function. These network devices may be interconnected through wired, wireless, optical, and other appropriate communication links.

In addition, client electronic devices 910 and 912 and/or a client smart device 914, may connect to network 902. Each of these devices is an example of data processing system 800, described above regarding FIG. 8. Client electronic devices 910, 912, and 914 may include, for example, one or more personal computers, network computers, and/or mobile computing devices such as personal digital assistants (PDAs), smart phones, handheld gaming devices, wearable devices, and/or tablet computers, and the like. In the depicted example, server 904 provides information, such as boot files, operating system images, and applications to one or more of client electronic devices 910, 912, and 914. Client electronic devices 910, 912, and 914 may be referred to as “clients” in the context of their relationship to a server such as server computer 904. Client devices may be in communication with one or more client data store(s) 920, which may be employed to store information local to the clients (e.g., cookie(s) and/or associated contextual information). Network data processing system 900 may include more or fewer servers and/or clients (or no servers or clients), as well as other devices not shown.

In some examples, first client electric device 910 may transfer an encoded file to server 904. Server 904 can store the file, decode the file, and/or transmit the file to second client electric device 912. In some examples, first client electric device 910 may transfer an uncompressed file to server 904 and server 904 may compress the file. In some examples, server 904 may encode text, audio, and/or video information, and transmit the information via network 902 to one or more clients.

Client smart device 914 may include any suitable portable electronic device capable of wireless communications and execution of software, such as a smartphone or a tablet. Generally speaking, the term “smartphone” may describe any suitable portable electronic device configured to perform functions of a computer, typically having a touchscreen interface, Internet access, and an operating system capable of running downloaded applications. In addition to making phone calls (e.g., over a cellular network), smartphones may be capable of sending and receiving emails, texts, and multimedia messages, accessing the Internet, and/or functioning as a web browser. Smart devices (e.g., smartphones) may also include features of other known electronic devices, such as a media player, personal digital assistant, digital camera, video camera, and/or global positioning system. Smart devices (e.g., smartphones) may be capable of connecting with other smart devices, computers, or electronic devices wirelessly, such as through near field communications (NFC), BLUETOOTH®, WiFi, or mobile broadband networks. Wireless connectively may be established among smart devices, smartphones, computers, and/or other devices to form a mobile network where information can be exchanged.

Data and program code located in system 900 may be stored in or on a computer-readable storage medium, such as network-connected storage device 908 and/or a persistent storage 808 of one of the network computers, as described above, and may be downloaded to a data processing system or other device for use. For example, program code may be stored on a computer-readable storage medium on server computer 904 and downloaded to client 910 over network 902, for use on client 910. In some examples, client data store 920 and server data store 922 reside on one or more storage devices 908 and/or 808.

Network data processing system 900 may be implemented as one or more of different types of networks. For example, system 900 may include an intranet, a local area network (LAN), a wide area network (WAN), or a personal area network (PAN). In some examples, network data processing system 900 includes the Internet, with network 902 representing a worldwide collection of networks and gateways that use the transmission control protocol/Internet protocol (TCP/IP) suite of protocols to communicate with one another. At the heart of the Internet is a backbone of high-speed data communication lines between major nodes or host computers. Thousands of commercial, governmental, educational and other computer systems may be utilized to route data and messages. In some examples, network 902 may be referred to as a “cloud.” In those examples, each server 904 may be referred to as a cloud computing node, and client electronic devices may be referred to as cloud consumers, or the like. In some examples, one or more processors, storage devices, and/or other components of a computer network may be utilized to implement a “feature as a service” (FaaS) architecture. FIG. 9 is intended as an example, and not as an architectural limitation for any illustrative embodiments.

### E. Illustrative Combinations and Additional Examples

This section describes additional aspects and features of the dispatch system and method for scheduling housekeepers presented without limitation as a series of paragraphs, some or all of which may be alphanumerically designated for clarity and efficiency. Each of these paragraphs can be combined with one or more other paragraphs, and/or with disclosure from elsewhere in this application, in any suitable manner. Some of the paragraphs below expressly refer to and further limit other paragraphs, providing without limitation examples of some of the suitable combinations.

A0. A method, implemented in a data processing system, the method comprising:

utilizing one or more processors of a data processing system, automatically categorizing a plurality of workers of a selected geographical zone into tiers comprising at least a first tier and a second tier, wherein the geographical zone is selected from a plurality of geographical zones, and each of the geographical zones includes a plurality of workers configured to provide services to a plurality of nodes disposed within the zone, and wherein a corresponding expected duration of service is associated with each of the nodes; and

utilizing the one or more processors, sequentially selecting individual workers of the selected one of the zones, based on the tiers, and for each of the individual workers generating a schedule, wherein generating the schedule includes assigning a series of the nodes in the selected geographical zone to fill an available span of time associated with the worker, based on the expected durations of service for the series of nodes and travel times between each of the nodes.

A1. The method of A0, wherein generating the schedule for each of the individual workers comprises minimizing a cost function based on the travel times between the nodes.

A2. The method of A0 or A1, further comprising:

for each schedule, removing the series of assigned nodes from a pool of potential nodes for subsequent workers;

wherein, for each of the selected workers, assigning the series of nodes includes analyzing all then-possible combinations of nodes.

A3. The method of any one of paragraphs A0 through A2, further comprising:

automatically partitioning the plurality of nodes to generate the plurality of geographical zones, based on a maximum node-to-node travel distance within each of the geographical zones, based on a maximum (or selected) number of nodes, based on a geographical area of the zone, based on a side length of the zone, and/or based on a selected distance or maximum distance from a point in each zone.

A4. The method of any one of paragraphs A0 through A3, further comprising:

automatically partitioning the plurality of nodes to generate the plurality of geographical zones, based on a maximum number of nodes per zone.

A5. The method of any one of paragraphs A0 through A4, wherein categorizing the workers of the selected one of the zones into tiers is based on a comparison between the expected durations of service and known durations of service associated with each worker.

A6. The method of A5, wherein workers are automatically selected from the first tier before the second tier, and new workers are categorized into the second tier.

A7. The method of A6, wherein the tiers further include a third tier, and, as the nodes are assigned, the workers of the first and second tiers are exhausted before selecting any worker from the third tier.

A8. The method of any one of paragraphs A0 through A7, wherein the available span of time associated with the worker is a shift being worked by the worker on a selected day, and the schedule is a shift schedule.

A9. The method of any one of paragraphs A0 through A8, wherein each node represents a building.

A10. The method of any one of paragraphs A0 through A8, wherein at least some of the nodes represent units (e.g., apartments or condominiums) within one or more buildings.

A11. The method of any one of paragraphs A0 through A10, wherein the expected duration of service for each node is determined using a machine learning algorithm.

A12. The method of A9 or A10, wherein the nodes are classified into two groups, a first group corresponding to nodes having a size less than a threshold value and a second group corresponding to nodes with a size greater than or equal to the threshold value.

A13. The method of paragraph A12, wherein the expected duration of service for the nodes in the first group is determined using linear regression and the expected duration of service for the nodes in the second group is determined using gradient boosted trees.

B0. A data processing system for scheduling workers with respect to a number of nodes, the data processing system comprising:

a memory;

one or more processors;

a plurality of instructions stored in the memory and executable by the one or more processors to:
automatically categorize a plurality of workers of a selected geographical zone into tiers comprising at least a first tier and a second tier, wherein the geographical zone is selected from a plurality of geographical zones, and each of the geographical zones includes a plurality of workers configured to provide services to a plurality of nodes disposed within the zone, and wherein a corresponding expected duration of service is associated with each of the nodes;
sequentially select individual workers of the selected one of the zones, based on the tiers; and
for each of the individual workers, generate a schedule, wherein generating the schedule includes assigning a series of the nodes in the selected geographical zone to fill an available span of time associated with the worker, based on the expected durations of service for the series of nodes and travel times between each of the nodes.

B1. The data processing system of B0, wherein generating the schedule for each of the individual workers comprises minimizing a cost function based on the travel times between the nodes.

B2. The data processing system of B0 or B1, wherein the instructions are further executable by the one or more processors to:

for each schedule, remove the series of assigned nodes from a pool of potential nodes for subsequent workers;

wherein, for each of the selected workers, assigning the series of nodes includes analyzing all then-possible combinations of nodes.

B3. The data processing system of B2, wherein categorizing the workers of the selected one of the zones into tiers is based on a comparison between the expected durations of service and known durations of service associated with each worker.

B4. The data processing system of B3, wherein workers are automatically selected from the first tier before the second tier, and new workers are categorized into the second tier.

B5. The data processing system of any one of paragraphs B0 through B4, wherein the available span of time associated with the worker is a shift being worked by the worker on a selected day, and the schedule is a shift schedule.

B6. The data processing system of any one of paragraphs B0 through B5, wherein the instructions are further executable by the one or more processors to transmit the schedule to a mobile digital device associated with the worker.

B7. The data processing system of any one of paragraphs B0 through B6, wherein each node represents a building.

B8. The data processing system of any one of paragraphs B0 through B6, wherein at least some of the nodes represent units (e.g., apartments or condominiums) within one or more buildings.

B9. The data processing system of any one of paragraphs B0 through B8, wherein the expected duration of service for each node is determined using a machine learning algorithm.

B10. The data processing system of paragraph B7 or B8, wherein the nodes are classified into two groups, a first group corresponding to nodes having a size less than a threshold value and a second group corresponding to nodes having a size greater than or equal to the threshold value.

B11. The data processing system of paragraph B10, wherein the expected duration of service for the nodes in the first group is determined using linear regression and the expected duration of service for the nodes in the second group is determined using gradient boosted trees.

C0. A system for scheduling a plurality of workers with respect to a plurality of locations, the system comprising processing logic configured to:

automatically categorize a plurality of workers of a selected geographical zone into tiers comprising at least a first tier and a second tier, wherein the geographical zone is selected from a plurality of geographical zones, and each of the geographical zones includes a plurality of workers configured to provide services to a plurality of nodes disposed within the zone, and wherein a corresponding expected duration of service is associated with each of the nodes; and

sequentially select individual workers of the selected one of the zones, based on the tiers; and

for each of the individual workers, generate a schedule, wherein generating the schedule includes assigning a series of the nodes in the selected geographical zone to fill an available span of time associated with the worker, based on the expected durations of service for the series of nodes and travel times between each of the nodes.

C1. The system of C0, wherein generating the schedule for each of the individual workers comprises minimizing a cost function based on the travel times between the nodes.

C2. The system of C0 or C1, wherein the processing logic is further configured to:

for each schedule, remove the series of assigned nodes from a pool of potential nodes for subsequent workers;

wherein, for each of the selected workers, assigning the series of nodes includes analyzing all then-possible combinations of nodes.

C3. The system of C0, C1, or C2, wherein categorizing the workers of the selected one of the zones into tiers is based on a comparison between the expected durations of service and known durations of service associated with each worker.

C4. The system of any one of paragraphs C1 through C3, wherein each node represents a building.

C5. The system of any one of paragraphs C0 through C4, wherein at least some of the nodes represent units (e.g., apartments or condominiums) within one or more buildings.

C6. The system of any one of paragraphs C0 through C5, wherein the expected duration of service for each node is determined using a machine learning algorithm.

C7. The system of paragraph C4 or C5, wherein the nodes are classified into two groups, a first group corresponding to nodes having a size less than a threshold value and a second group corresponding to nodes having a size greater than or equal to the threshold value.

C8. The system of paragraph C7, wherein the expected duration of service for the nodes in the first group is determined using linear regression and the expected duration of service for the nodes in the second group is determined using gradient boosted trees.

### Advantages, Features, and Benefits

The different embodiments and examples of the dispatch system and the method for scheduling housekeepers described herein provide several advantages over known solutions for dispatching workers to multiple sites and generating associated schedules. For example, illustrative embodiments and examples described herein allow for more relevant association between the workers and their scheduled units (e.g., scheduling workers to units that are a reasonable commuting distance away).

Additionally, and among other benefits, illustrative embodiments and examples described herein allow a decreased computational complexity over known dispatch systems.

Additionally, and among other benefits, illustrative embodiments and examples described herein allow the scheduling of workers based on performance, introducing systemic biasing to increase retention of high-performance workers.

No known system or device can perform these functions. However, not all embodiments and examples described herein provide the same advantages or the same degree of advantage.

### CONCLUSION

The disclosure set forth above may encompass multiple distinct examples with independent utility. Although each of these has been disclosed in its preferred form(s), the specific embodiments thereof as disclosed and illustrated herein are not to be considered in a limiting sense, because numerous variations are possible. To the extent that section headings are used within this disclosure, such headings are for organizational purposes only. The subject matter of the disclosure includes all novel and nonobvious combinations and subcombinations of the various elements, features, functions, and/or properties disclosed herein. The following claims particularly point out certain combinations and subcombinations regarded as novel and nonobvious. Other combinations and subcombinations of features, functions, elements, and/or properties may be claimed in applications claiming priority from this or a related application. Such claims, whether broader, narrower, equal, or different in scope to the original claims, also are regarded as included within the subject matter of the present disclosure.

1. A method, implemented in a data processing system, the method comprising:
utilizing one or more processors of a data processing system, automatically categorizing a plurality of workers of a selected geographical zone into tiers comprising at least a first tier and a second tier, wherein the geographical zone is selected from a plurality of geographical zones, and each of the geographical zones includes a plurality of workers configured to provide services to a plurality of nodes disposed within the zone, and wherein a corresponding expected duration of service is associated with each of the nodes; and
utilizing the one or more processors, sequentially selecting individual workers of the selected one of the zones, based on the tiers, and for each of the individual workers generating a schedule, wherein generating the schedule includes assigning a series of the nodes in the selected geographical zone to fill an available span of time associated with the worker, based on the expected durations of service for the series of nodes and travel times between each of the nodes.

2. The method of claim 1, wherein generating the schedule for each of the individual workers comprises minimizing a cost function based on the travel times between the nodes.

3. The method of claim 1, further comprising:
for each schedule, removing the series of assigned nodes from a pool of potential nodes for subsequent workers;
wherein, for each of the selected workers, assigning the series of nodes includes analyzing all then-possible combinations of nodes.

4. The method of claim 1, further comprising:
automatically partitioning the plurality of nodes to generate the plurality of geographical zones, based on a maximum node-to-node travel distance within each of the geographical zones.

5. The method of claim 1, further comprising:
automatically partitioning the plurality of nodes to generate the plurality of geographical zones, based on a maximum number of nodes per zone.

6. The method of claim 1, wherein categorizing the workers of the selected one of the zones into tiers is based on a comparison between the expected durations of service and known durations of service associated with each worker.

7. The method of claim 6, wherein workers are automatically selected from the first tier before the second tier, and new workers are categorized into the second tier.

8. The method of claim 7, wherein the tiers further include a third tier, and, as the nodes are assigned, the workers of the first and second tiers are exhausted before selecting any worker from the third tier.

9. The method of claim 1, wherein the available span of time associated with the worker is a shift being worked by the worker on a selected day, and the schedule is a shift schedule.

10. A data processing system for scheduling workers with respect to a number of nodes, the data processing system comprising:
a memory;
one or more processors;
a plurality of instructions stored in the memory and executable by the one or more processors to:
automatically categorize a plurality of workers of a selected geographical zone into tiers comprising at least a first tier and a second tier, wherein the geographical zone is selected from a plurality of geographical zones, and each of the geographical zones includes a plurality of workers configured to provide services to a plurality of nodes disposed within the zone, and wherein a corresponding expected duration of service is associated with each of the nodes;
sequentially select individual workers of the selected one of the zones, based on the tiers; and
for each of the individual workers, generate a schedule, wherein generating the schedule includes assigning a series of the nodes in the selected geographical zone to fill an available span of time associated with the worker, based on the expected durations of service for the series of nodes and travel times between each of the nodes.

11. The data processing system of claim 10, wherein generating the schedule for each of the individual workers comprises minimizing a cost function based on the travel times between the nodes.

12. The data processing system of claim 10, wherein the instructions are further executable by the one or more processors to:
for each schedule, remove the series of assigned nodes from a pool of potential nodes for subsequent workers;
wherein, for each of the selected workers, assigning the series of nodes includes analyzing all then-possible combinations of nodes.

13. The data processing system of claim 10, wherein categorizing the workers of the selected one of the zones into tiers is based on a comparison between the expected durations of service and known durations of service associated with each worker.

14. The data processing system of claim 13, wherein workers are automatically selected from the first tier before the second tier, and new workers are categorized into the second tier.

15. The data processing system of claim 10, wherein the available span of time associated with the worker is a shift being worked by the worker on a selected day, and the schedule is a shift schedule.

16. The data processing system of claim 10, wherein the instructions are further executable by the one or more processors to transmit the schedule to a mobile digital device associated with the worker.

17. A system for scheduling a plurality of workers with respect to a plurality of locations, the system comprising processing logic configured to:
automatically categorize a plurality of workers of a selected geographical zone into tiers comprising at least a first tier and a second tier, wherein the geographical zone is selected from a plurality of geographical zones, and each of the geographical zones includes a plurality of workers configured to provide services to a plurality of nodes disposed within the zone, and wherein a corresponding expected duration of service is associated with each of the nodes; and
sequentially select individual workers of the selected one of the zones, based on the tiers; and
for each of the individual workers, generate a schedule, wherein generating the schedule includes assigning a series of the nodes in the selected geographical zone to fill an available span of time associated with the worker, based on the expected durations of service for the series of nodes and travel times between each of the nodes.

18. The system of claim 17, wherein generating the schedule for each of the individual workers comprises minimizing a cost function based on the travel times between the nodes.

19. The system of claim 17, wherein the processing logic is further configured to:
for each schedule, remove the series of assigned nodes from a pool of potential nodes for subsequent workers;
wherein, for each of the selected workers, assigning the series of nodes includes analyzing all then-possible combinations of nodes.

20. The system of claim 17, wherein categorizing the workers of the selected one of the zones into tiers is based on a comparison between the expected durations of service and known durations of service associated with each worker.
